(19) United States
(12) Patent Application Publication
(10) Pub. No.: US 2012/0006429 A1
(43) Pub. Date: Jan. 12, 2012

(54) Safety valve

(76) Inventor: Wan-Bau Chen, Changhua (TW)

(21) Appl. No.: 12/832,063

(22) Filed: Jul. 7, 2010

(51) Int. Cl. F16K 17/04

(52) U.S. Cl. 137/535

(57) ABSTRACT

A safety valve includes a valve body comprising a central passage, internal threads at one end, and an externally threaded neck at the other end; a hollow spring operated poppet comprising an externally and internally threaded proximal portion secured to the internal threads, a smaller distal portion, and a central bore; a hollow sliding member in the passage urged by the poppet, the sliding member comprising a grooved rim at one end, a projection at the other end, and two opposite exhaust ports through the projection; and first and second seals for sealingly engaging the distal portion with the sliding member and engaging the sliding member with the passage respectively. In response to directing gas through the bore and the exhaust ports into the neck and pressure of the gas exceeds a preset limit, the gas pushes the sliding member toward the proximal portion.

### BACKGROUND OF THE INVENTION

1. Field of Invention

The invention relates to pressure relieving devices and more particularly to an improved safety valve.

2. Description of Related Art

Typically, a safety valve is an automatic system that relieves gas pressure above a predetermined maximum pressure limit.

A typical safety valve comprises a threaded housing having a channel for the passage of gas adapted to be received in the cylinder port below the primary gas valve, a tubular portion of the threaded housing extending into a gas passage of the primary gas valve; a cylindrical housing adapted to be received inside the cylinder and attached to the threaded housing having an aperture for the passage of gas from the cylinder to the threaded housing; a poppet seat disposed in the threaded housing; a poppet disposed in the cylindrical housing; a spring member disposed in the cylindrical housing to urge the poppet into the poppet seat; and a frangible element disposed in the threaded housing and holding the poppet off the poppet seat against the urging of the spring member whereby upon the severing or the deflection of the primary gas valve the frangible element will break, thereby allowing the poppet to seat in the poppet seat and preventing the flow of gas from the cylinder to the primary valve.

However, as far as the present inventor is aware, there are no documents disclosing a safety valve being cost effective, simple, and efficient. Thus, the need for improvement still exists.

### SUMMARY OF THE INVENTION

It is therefore one object of the invention to provide a safety valve comprising a valve body comprising a central passage, internal threads at one end of the passage, and an externally threaded neck projecting out of the other end of the passage; a hollow spring operated poppet comprising an externally and internally threaded proximal portion threadedly secured to the internal threads, a distal portion having a diameter less than that of the proximal portion, and a central bore; a hollow sliding member in the passage and urged by the poppet, the sliding member comprising a grooved rim at one end, a projection at the other end, and two opposite exhaust ports through the projection; first sealing means for sealingly engaging the distal portion with the sliding member; and second sealing means for sealingly engaging the sliding member with the passage, wherein in response to directing gas through the bore and the exhaust ports into the neck and pressure of the gas exceeds a predetermined pressure value, the gas pushes the sliding member toward the proximal portion.

The above and other objects, features and advantages of the invention will become apparent from the following detailed description taken with the accompanying drawings.

### BRIEF DESCRIPTION OF THE DRAWINGS

FIG. 1 is an exploded view of a safety valve according to the invention;

FIG. 2 is a perspective view of the assembled safety valve;

FIG. 3 is a longitudinal sectional view of the safety valve in FIG. 2 showing a normal state when gas pressure is below a maximum pressure limit;

FIG. 4A a view similar to FIG. 3 showing gas pressure being increased gradually but still below the maximum pressure limit; and

FIG. 4B is a view similar to FIG. 4A showing gas pressure having been increased beyond the maximum pressure limit and a rapid exhaustion of excess gas pressure being done in response.

### DETAILED DESCRIPTION OF THE INVENTION

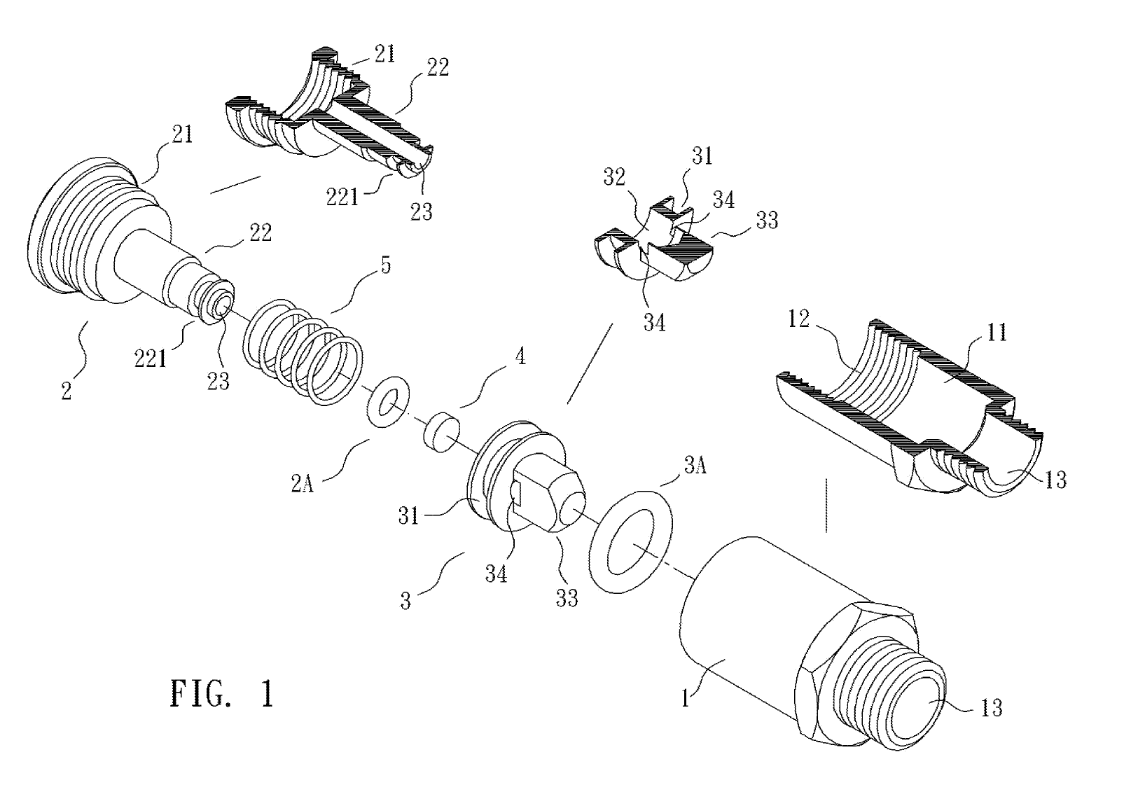

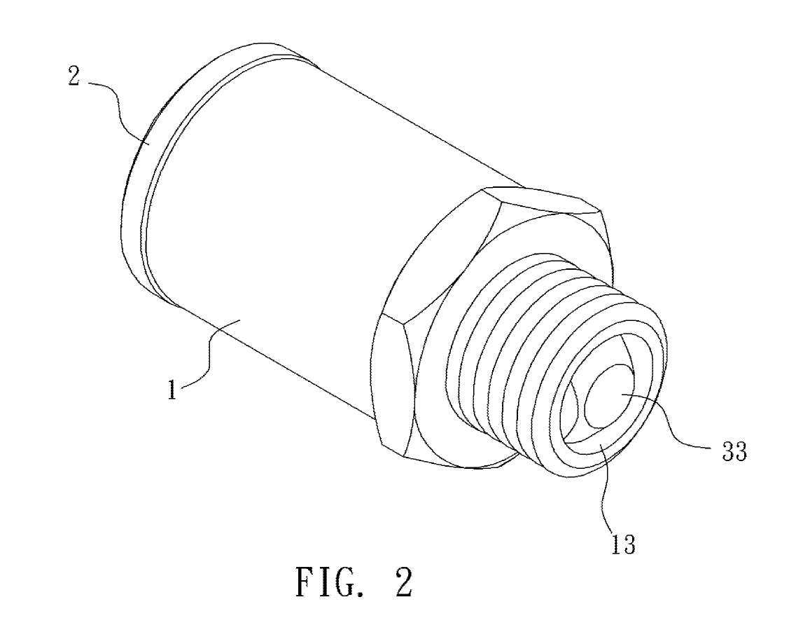

Referring to FIGS. 1 to 4B, a safety valve in accordance with the invention comprises the following components as discussed in detail below.

A hollow, cylindrical valve body 1 comprises a central passage 11, internal threads 12 at one end of the passage 11, and an externally threaded neck 13 projecting out of the other end of the passage 11.

A poppet assembly comprises a poppet 2 including a proximal portion 21 having internal and external threads, a distal portion 22 of stepped diameter having a diameter less than that of the proximal portion 21, the distal portion 22 having an annular groove 221 at the other end distal the proximal portion 21, and a central bore 23 through the poppet 2.

A poppet assembly further comprises a sealing ring 2A put on the groove 221, a helical spring 5, and a sliding member 3 including a grooved rim 31 at one end with a seal 3A put thereon, a cylindrical internal space 32, a projection 33 at the other end, and two opposite exhaust ports 34 through two flat sides of the projection 33 respectively.

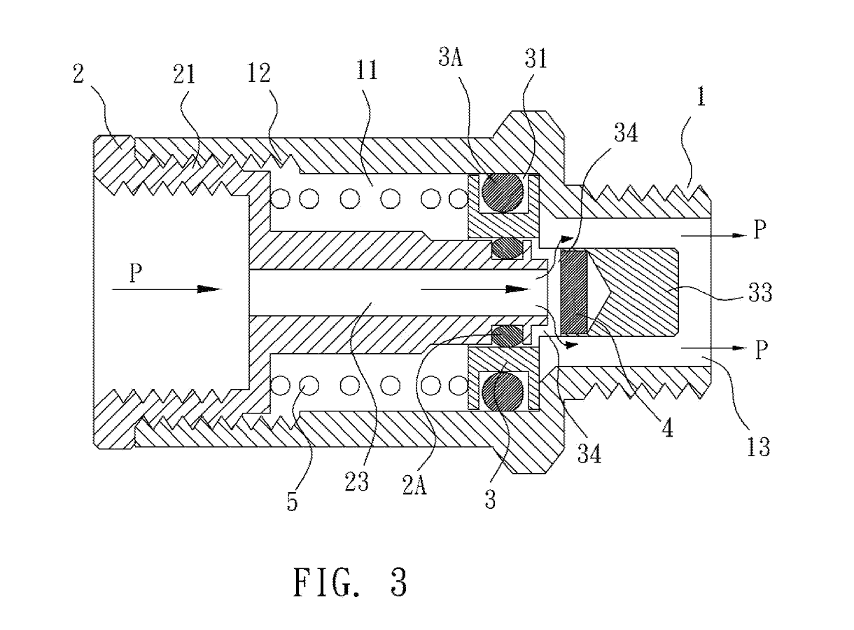

In assembly, a disc shaped retainer 4 is anchored within the projection 33 after passing the space 32. The sliding member 3 is disposed in the neck 13 to have the rim 31 engage with an annular shoulder within the passage 11. The spring 5 is put on the distal portion 22 to have one end engaged with a joining shoulder of the proximal portion 21 and the distal portion 22. Finally, mount the poppet 2 in the valve body 1 by threadedly securing the external threads of the proximal portion 21 to the internal threads 12. In this state, the spring 5 has one end urged against the joining shoulder of the proximal portion 21 and the distal portion 22 and the other end push the sliding member 3 to urge the grooved rim 31 against the annular shoulder within the passage 11. This is shown in FIG. 3. A pressure source (not shown) can communicate with the poppet 2 by theadedly securing a connector to the internal threads of the proximal portion 21. Also, a destination (not shown) can communicate with the valve body 1 by threadedly securing a connector to the externally threaded neck 3. In the normal state (i.e., gas pressure below a maximum pressure limit) of FIG. 3, gas may flow from the pressure source to the destination via a path of the poppet 2, the exhaust ports 34, and the neck 13 (as indicated by arrows P).

It is noted that the provision of the seal 3A can effect a leak free engagement of the sliding member 3 with the inner surface of the valve body 1. Further, the provision of the sealing ring 2A can effect a leak free engagement of the sliding member 3 with the distal portion 22 of the poppet 2.

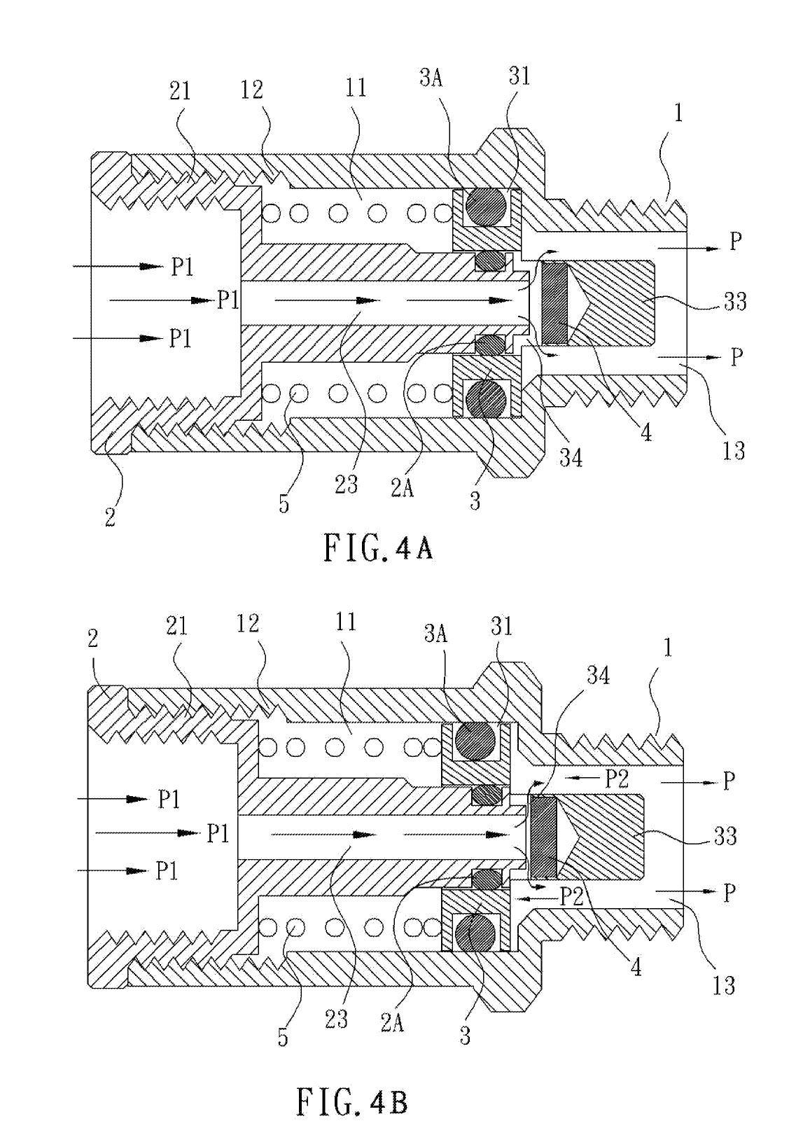

In FIG. 4A, it shows inlet gas pressure is increased gradually (as indicated by three arrows P1) but still below the maximum pressure limit. Thus, gas with a pressure below the maximum pressure limit can be continuously supplied to the destination (as indicated by two arrows P).

In FIG. 4B, it shows inlet gas pressure having increased beyond the maximum pressure limit (as indicated by three arrows P1). Further, a partial pressure (as indicated by two arrows P2) in the neck 13 may exert force on the grooved rim 31 to push the sliding member 3 toward the proximal portion 21 by compressing the spring 5. This has the function of decreasing gas pressure in substantially real time. As a result, pressure of the output gas is always kept below the maximum pressure limit.

While the invention has been described in terms of preferred embodiments, those skilled in the art will recognize that the invention can be practiced with modifications within the spirit and scope of the appended claims.

What is claimed is:

1. A safety valve comprising:
a valve body (1) comprising a central passage (11), internal threads (12) at one end of the passage (11), and an externally threaded neck (13) projecting out of the other end of the passage (11);
a hollow spring operated poppet (2) comprising an externally and internally threaded proximal portion (21) threadedly secured to the internal threads (12), a distal portion (22) having a diameter less than that of the proximal portion (21), and a central bore (23);
a hollow sliding member (3) disposed in the passage (11) and urged by the poppet (2), the sliding member (3) comprising a grooved rim (31) at one end, a projection (33) at the other end, and two opposite exhaust ports (34) through the projection (33);
first sealing means (2A) for sealingly engaging the distal portion (22) with the sliding member (3); and
second sealing means (3A) for sealingly engaging the sliding member (3) with the passage (11),
wherein in response to directing compressible fluid through the bore (23) and the exhaust ports (34) into the neck (13) and pressure of the compressible fluid exceeds a predetermined pressure value, the compressible fluid in the neck (13) pushes the sliding member (3) toward the proximal portion (21).
